(19) United States
(12) Patent Application Publication
(10) Pub. No.: US 2003/0183642 A1
(43) Pub. Date: Oct. 2, 2003

(54) Pill dispensing apparatus

(76) Inventor: Jeffrey A. Kempker SR., Muskegon, MI (US)

Correspondence Address: HARSHAW RESEARCH INCORPORATED, P O BOX 418, OTTAWA, KS, 66067, US

(21) Appl. No.: 10/106,615

(22) Filed: Mar. 26, 2002

(51) Int. Cl. G07F 11/00

(52) U.S. Cl. 221/2

(57) ABSTRACT

A pill dispensing apparatus includes a container capable of holding a plurality of pills of a type of medication. A bottom wall of the container defines an opening. The apparatus includes a housing defining an interior space and having a top wall defining an aperture, the aperture and bottom wall opening having complementary configurations. The container may be positioned on the housing such that the opening and aperture are aligned. A dispensing assembly mounted within the housing includes a pair of wheels positioned so as to convey a single pill from the container therebetween and to an outlet when the wheels are rotated in opposing directions. A motor energized by a control unit according to previously entered dosage data causes the wheels to rotate until a photoelectric sensor detects that the pill has been dispensed. In another embodiment, a knob connected to the wheels allows manual wheel rotation.

### BACKGROUND OF THE INVENTION

This invention relates to medication dispensers and, more particularly, to a pill dispensing apparatus which automatically dispenses single pill dosages from one or more containers of medicine at predetermined times.

Various devices have been proposed in the art for dispensing tablets, capsules, and the like from preloaded compartments of a carousel, cassette, or the like. Although assumably effective for their intended purposes, the existing device requires the storage compartments to be preloaded and presorted by the user. More particularly, appropriate combinations of pills must be sorted and deposited into specific compartments for later use. This preparation is inconvenient, time-consuming, and especially difficult for consumers with decreased dexterity.

Therefore, it is desirable to have a pill dispensing apparatus that dispenses one or more single doses of pill medication from one or more containers of medication at predetermined times. Further, it is desirable that combinations of medications need not be preloaded into dispenser containers. Finally, it is desirable to have a pill dispensing apparatus in which pills of the same medication are held together in a container until dispensed.

### SUMMARY OF THE INVENTION

A pill dispensing apparatus according to the present invention includes a housing having bottom and top walls with upstanding side walls extending therebetween so as to define an open interior space. The apparatus includes a plurality of pill containers held atop the housing, each pill container adapted to hold a supply of single dosages of a particular pharmaceutical prescription. Each container defines an opening in a bottom wall thereof that registers with a corresponding opening in the top wall of the housing. A dispensing assembly mounted within the housing includes a pair of wheels positioned so as to convey a single pill from a pill container therebetween and then to an outlet when the wheels are rotated in opposing directions. A motor energized by a control unit according to previously entered dosage data causes the wheels to rotate until a photoelectric sensor detects that the pill has been completely dispensed.

Therefore, a user may dump an entire prescription (or a desired portion thereof) into a pill container and then enter dosage instructions into the control unit. At appropriate times, the control unit will energize the motors of the dispensing assembly to dispense a single pill from appropriate containers. Thus, combinations of pills to be dispensed at particular times need not be pre-sorted into a plurality of individual dosage compartments. In another embodiment, manual knob controls are substituted for the motors such that a user may manually dispense pills from the containers.

Therefore, a general object of the present invention is to provide a pill dispensing apparatus which dispenses single doses of pill medication at predetermined times.

Another object of this invention is to provide a pill dispensing apparatus, as aforesaid, which does not require pre-loading of individual dispensing compartments.

Still another object of this invention is to provide a pill dispensing apparatus, as aforesaid, which can hold multiple prescriptions in respective containers.

Yet another object of this invention is to provide a pill dispensing apparatus, as aforesaid, that can automatically dispense a single pill from a container of pills without damaging the dispensed pill.

A further object of this invention is to provide a pill dispensing apparatus, as aforesaid, having audible and visual alarms that provide notice that it is time for a user to receive and take medication.

A still further object of this invention is to provide a pill dispensing apparatus, as aforesaid, that provides for manual dispensing of pills from a pill container.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a pill dispensing apparatus according to one embodiment of the present invention;

FIG. 2 is an elevated perspective view of the apparatus as in FIG. 1 with a front window removed;

FIG. 3 is a perspective view of the apparatus as in FIG. 1 with upper portions of the housing and control unit removed and with a pill container partially removed;

FIG. 4 is a fragmentary view of a control unit of the apparatus;

FIG. 5a is a side view of the upper portions as in FIG. 3 with a side wall broken away to show a dispensing assembly;

FIG. 5b is a side view of the dispensing assembly as in FIG. 5a on an enlarged scale;

FIG. 6 is a side view of the dispensing assembly as in FIG. 5b on an enlarged scale in a second configuration conveying a pill;

FIG. 7 is a block diagram of the apparatus as in FIG. 1;

FIG. 8a is a front perspective view of a wheel of the dispensing assembly as in FIG. 5b;

FIG. 8b is a rear perspective view of a wheel of the dispensing assembly as in FIG. 5b;

FIG. 9 is a perspective view of the apparatus as in FIG. 3 with a side wall broken away and a dispensing assembly and pill containers removed;

FIG. 10 is a perspective view of a pill dispensing apparatus according to another embodiment of the present invention;

FIG. 11 is a rear view of the apparatus as in FIG. 10 with a side wall partially broken away and a rear-side dispensing assembly removed to show a front-side dispensing assembly;

FIG. 12 is a fragmentary view of the front-side dispensing assembly as in FIG. 11 on an enlarged scale; and

FIG. 13 is a perspective view of a pill dispensing apparatus according to another embodiment of the present invention.

### DESCRIPTION OF THE PREFERRED EMBODIMENT

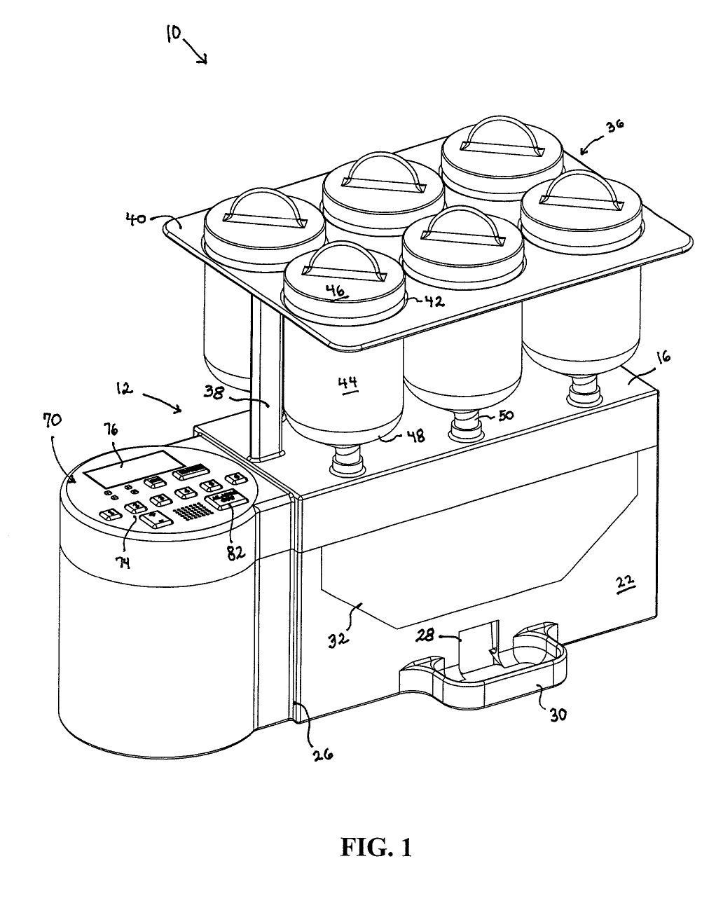

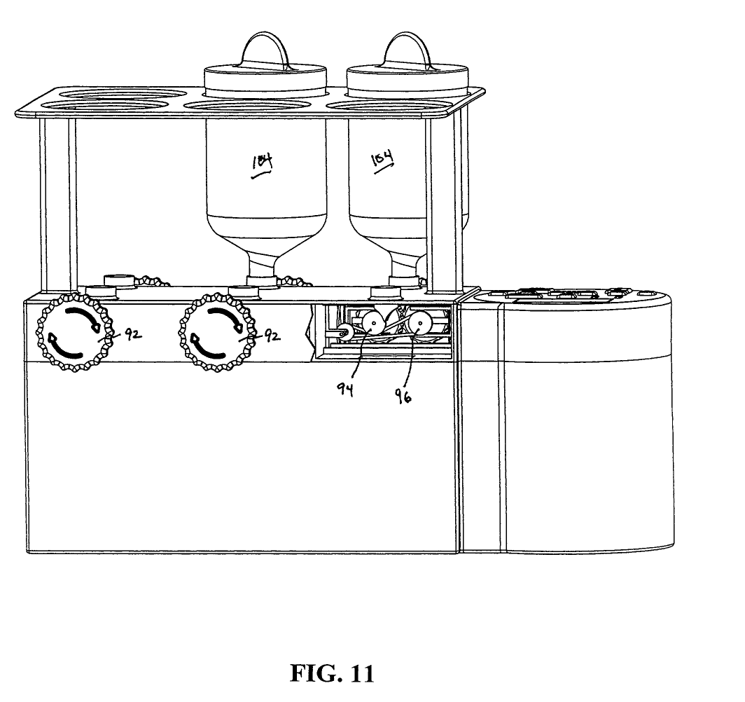

A pill dispensing apparatus according to the present invention will now be described in detail with reference to FIGS. 1 through 13 of the accompanying drawings.

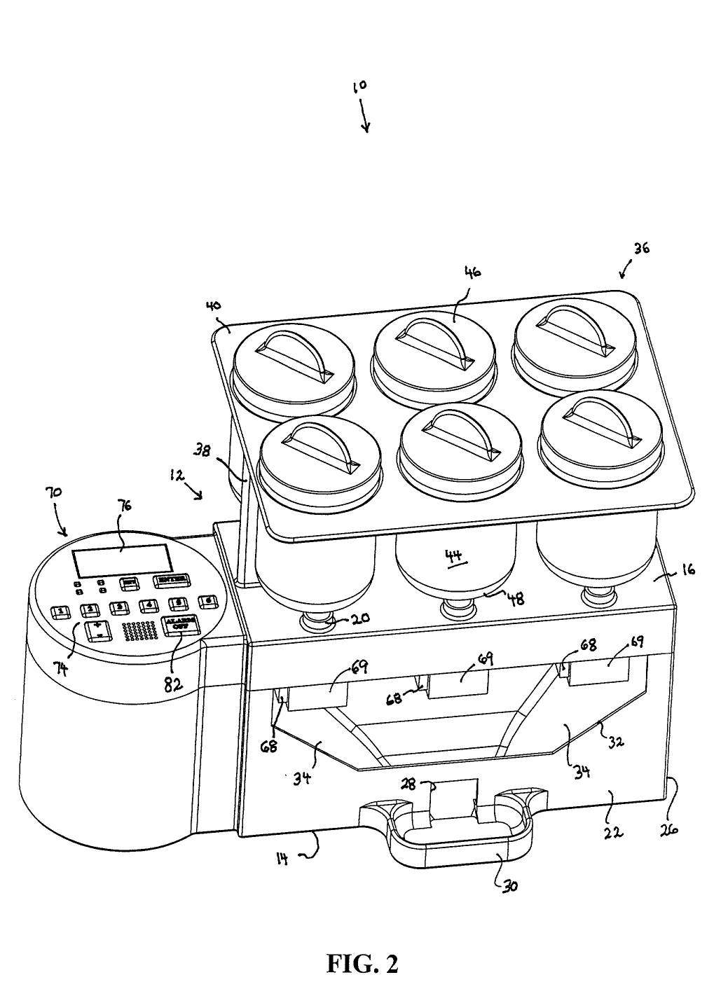

A pill dispensing apparatus 10 according to one embodiment of the present invention is shown in FIGS. 1 through 9. The apparatus 10 includes a housing 12 having bottom 14 and top 16 walls with upstanding front 22, rear, and side 26 walls extending therebetween such that the housing 12 defines an interior space (FIG. 1). The front wall 22 defines an outlet opening 28 adjacent the bottom wall 14. A tray 30 is fixedly attached to an outer surface of the front wall 22 and positioned at the outlet opening 28. The front wall 22 may include a transparent or translucent window 32 that enables a user to see pills being dispensed therein. One or more ramps 34 are positioned within the interior space of the housing 12 (FIG. 2), each ramp being configured to direct a pill toward the outlet opening 28 during use, as to be described further below.

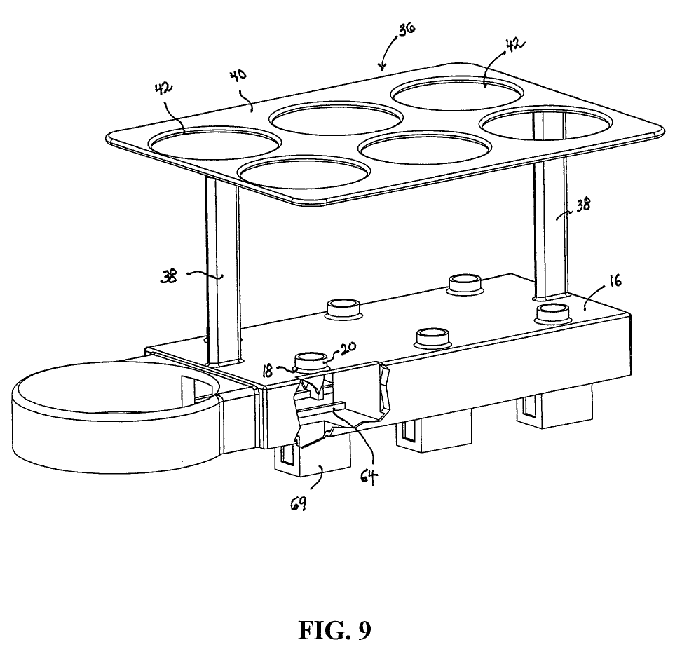

The apparatus 10 includes a rack 36 having a pair of upstanding legs 38 mounted atop the top wall 16 of the housing 12 and having a plate 40 extending between the legs 38 (FIG. 1). The plate 40 defines a plurality of apertures 42 (FIG. 9). The apparatus 10 further includes a plurality of pill containers 44, each container capable of holding a plurality of single doses of medication, such as tablets, capsules, or pills. Of course, a pill dispensing apparatus having only one pill container or having individual racks or brackets holding each of multiple containers would also work. It is understood that each pill container 44 is for holding pills of a single prescription. Preferably, each container 44 includes a cylindrical configuration although other configurations would also be suitable. The configuration of a pill container 44 is complementary to the configuration of a rack aperture 42 such that the container is held in a stable relationship within the rack 36. Further, each container 44 includes a transparent construction such that a user can easily see how many pills of a prescription are remaining and whether a refill is needed. Each container 44 may also include a space between a pair of side walls into which a label identifying the prescription may be inserted. The containers may also include color-coded indicia to aid identification.

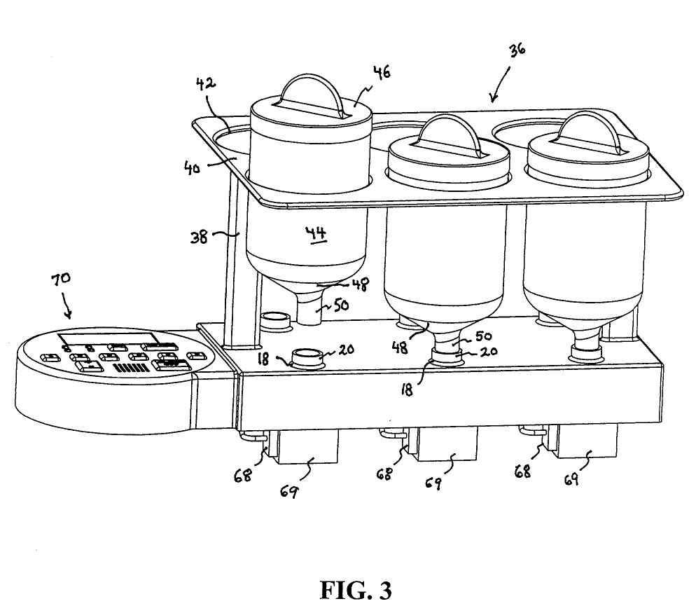

Each container 44 defines an open top such that a plurality of pills, such as pharmacy-filled prescription medication, may be dumped therein and held in the container 44. Each container 44 includes a corresponding cap 46 that may be removably positioned to cover the respective open top (FIG. 1). Each container 44 further includes a bottom wall 48 defining an opening, the opening having a diameter suitable for the passage of the pills held in the respective container 44. It is understood that the containers 44 and the bottom wall openings may be of different sizes so as to be useful for use with different sizes of pills (e.g., small, medium, and large tubes and openings). Each container 44 further includes a funnel 50 depending from a respective container bottom wall and positioned about a respective bottom wall opening. Each funnel 50 includes an offset configuration such that pills descending therethrough are directed in a single file alignment (FIG. 3). The diameter of each funnel 50 may be sized for use with pills of corresponding size so as to effectuate single file alignment and prevent clogging or jamming.

The top wall 16 of the housing 12 defines a plurality of apertures 18 that are spaced apart so as to correspond with the funnels 50 of the pill containers 44 (FIG. 3). Each aperture includes a retaining ring 20 (FIG. 9) for securely receiving a respective funnel 50. The funnels 50 are not attached to the rings 20; thus, the containers 44 may be removed, replaced, or substituted as desired by a user.

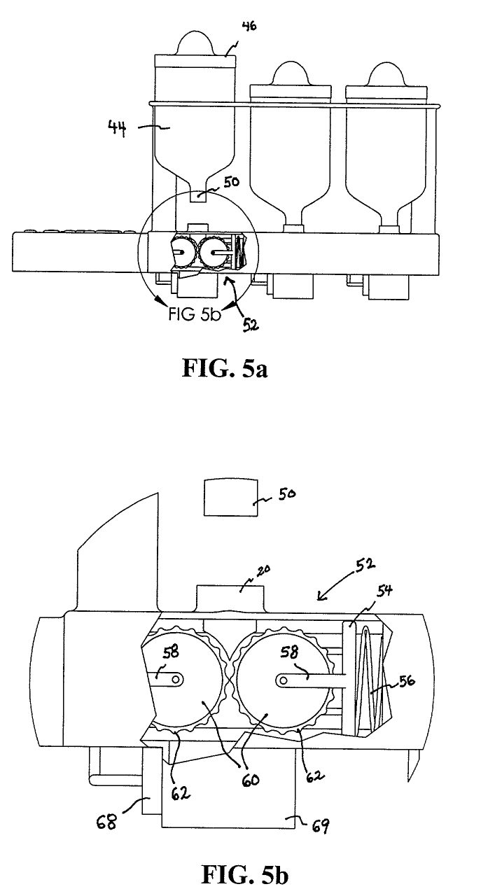

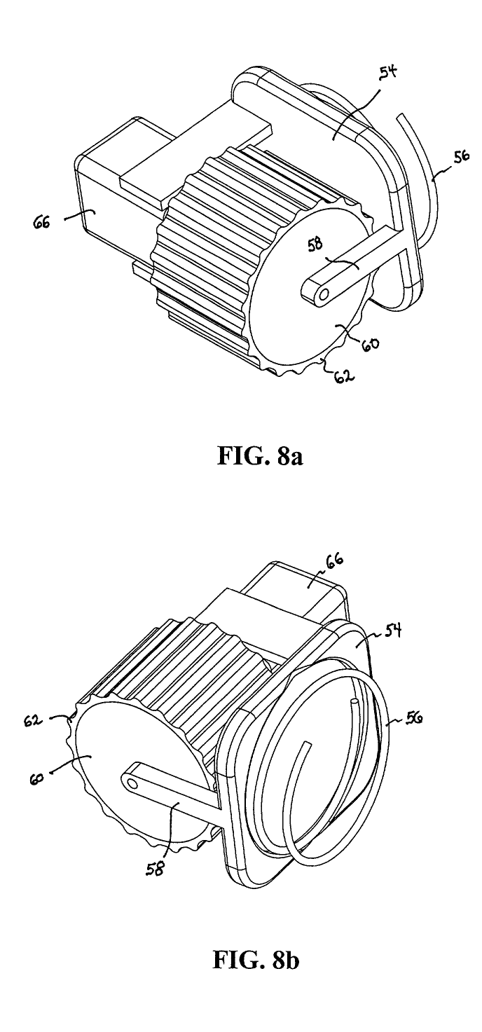

A pill dispensing assembly 52 is mounted within the interior space of the housing 12 immediately beneath each respective aperture 18 in the top wall 16 (FIG. 5b). Therefore, pills descending through a funnel 50 are deposited into a respective dispensing assembly 52. Each dispensing assembly 52 includes a framework having a pair of flat frame elements 54 biased toward one another with respective compression springs 56 (FIG. 5b). Each spring 56 is fixedly attached to the framework and normally pushes a respective frame element 54 in the direction of a corresponding frame element 54. Each frame element 54 includes at least one mounting arm 58. The dispensing assembly 52 includes a pair of wheels 60, each wheel being rotatably mounted to a respective mounting arm 58. Each wheel 60 includes a grip surface 62 having a rubber construction and a plurality of ribs although other materials having grip characteristics would also be suitable (FIGS. 8a and 8b). The framework includes a pair of rails 64 for guiding the frame elements as they move in back and forth movement (FIG. 9), as to be described more fully below.

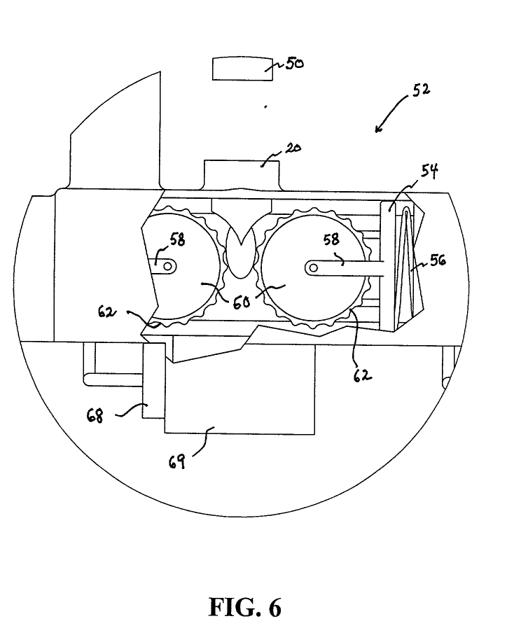

A motor 66 is connected to each pair of wheels 60 for rotating the wheels when the motor is energized. Of course, a separate motor may be attached to each wheel although it is preferred to have a single motor connected to a pair of wheels with an appropriate connecting shaft linkage. Each motor 66 is electrically connected to a control unit 70 and may be energized thereby, as to be described more fully later. When the motor 66 is energized, a corresponding pair of wheels 60 rotates in opposing directions. A single pill descending into a respective dispensing apparatus from a respective funnel 50 is then conveyed between the rotating wheels (FIG. 6). The pressure of the single pill causes the respective wheels and frame elements to compress respective springs 56 so as to alleviate pressure bearing against the pill. Therefore, the wheels and frame elements of the dispensing assembly are slidably movable between a first configuration in which edges of the wheels bear substantially against one another (FIG. 5b) and a second configuration in which the wheel edges are spaced apart (FIG. 6). A pill being conveyed between a pair of wheels, therefore, is not damaged.

A photoelectric sensor 68 is mounted below each dispensing assembly 52. Each photoelectric sensor 68 is electrically connected to the control unit 70 although it may also be connected to a respective motor 66. When a single pill is conveyed between a pair of wheels 60 and drops through a chute 69 into the interior space, a respective photoelectric sensor 68 detects the pill as it drops through the chute and delivers an electrical signal to the control unit 70, whereby to de-energize a respective motor 66. Of course, if the predetermined dosage instructions call for the dispensing of more than one pill, the motor 66 is either not de-energized or is re-energized to dispense another pill.

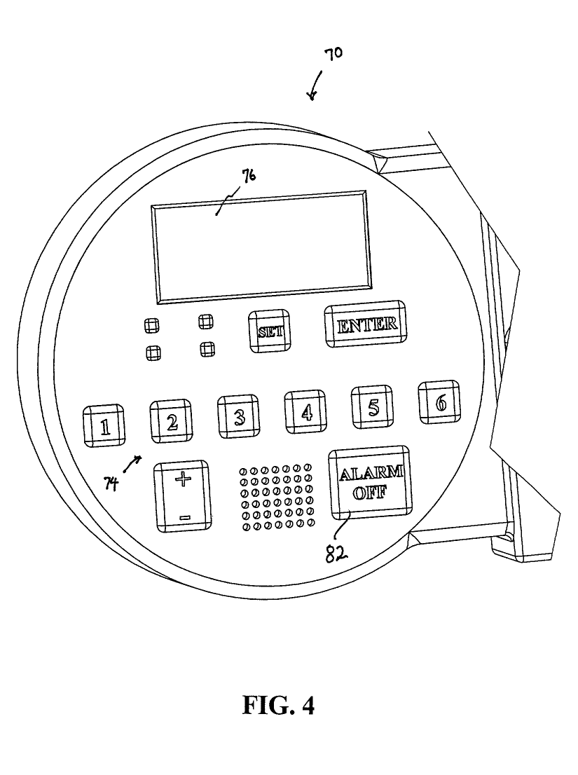

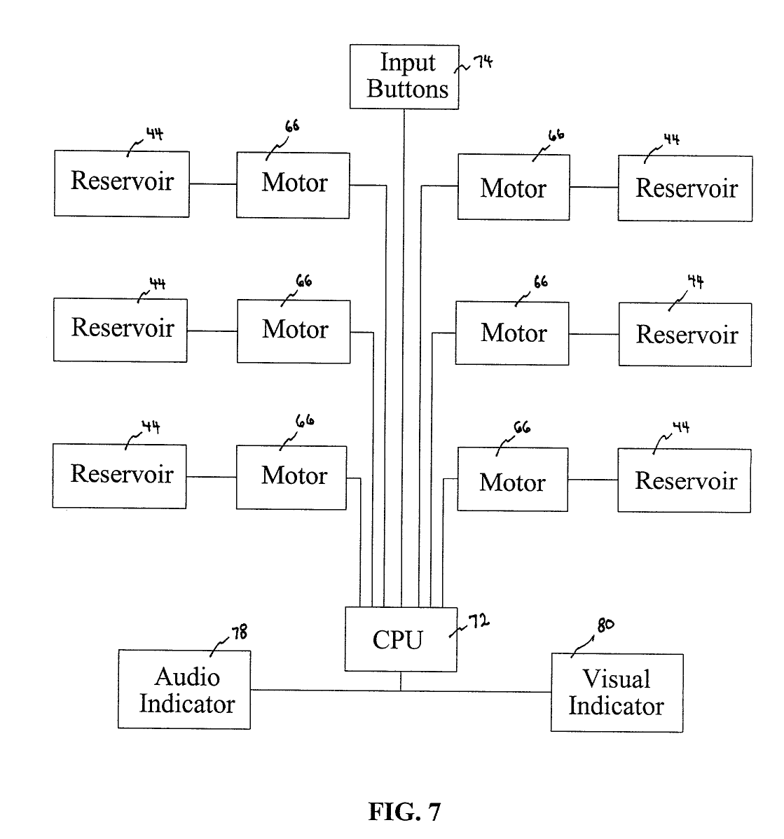

The pill dispensing apparatus 10 includes a control unit 70 fixedly attached to one side of the housing 12 (FIG. 2). The control unit 70 includes a processor 72 having a memory, and a keypad of input buttons 74 and display 76 electrically connected to the processor 72 (FIG. 4). The control unit 70 also includes audible 78 and visual 80 alarms connected to the processor 72 (FIG. 7). The control unit 70 further includes an alarm de-activation button 82 (FIG. 4). The processor 72 is electrically connected to the motors 66. Therefore, a user may input dosage information using the input buttons 74, such as when pills from particular pill containers 44 should be automatically dispensed. The alarms are energized at these preset times.

In use, a user may insert pill containers 44 into the rack 36 as desired. Specifically, the user may choose containers having container and funnel dimensions corresponding to particular prescription pill sizes. In other words, containers having smaller dimensions or smaller funnel dimensions may be utilized for use with small pills. Then, the user may empty (or substantially empty) a prescription bottle of medication into a single pill container. These steps may be repeated for multiple medications. The user may then enter dosage instructions into the control unit 70, such as when to dispense pills from respective pill containers 44. Each container 44 corresponds to a particular number for purposes of programming the control unit 70. According to the dosage data, the control unit processor 72 energizes respective motors 66 at the appropriate times to rotate respective wheels 60 and dispense single pills from appropriate pill containers 44 into the outlet tray 30. Concurrently, the processor 72 energizes the alarms 78, 80 and displays the predetermined container numbers and dosage data. As a pill is dispensed, a respective photoelectric sensor 68 detects the motion of the pill and delivers a signal to the control unit 70, whereby to de-energize a respective motor 66.

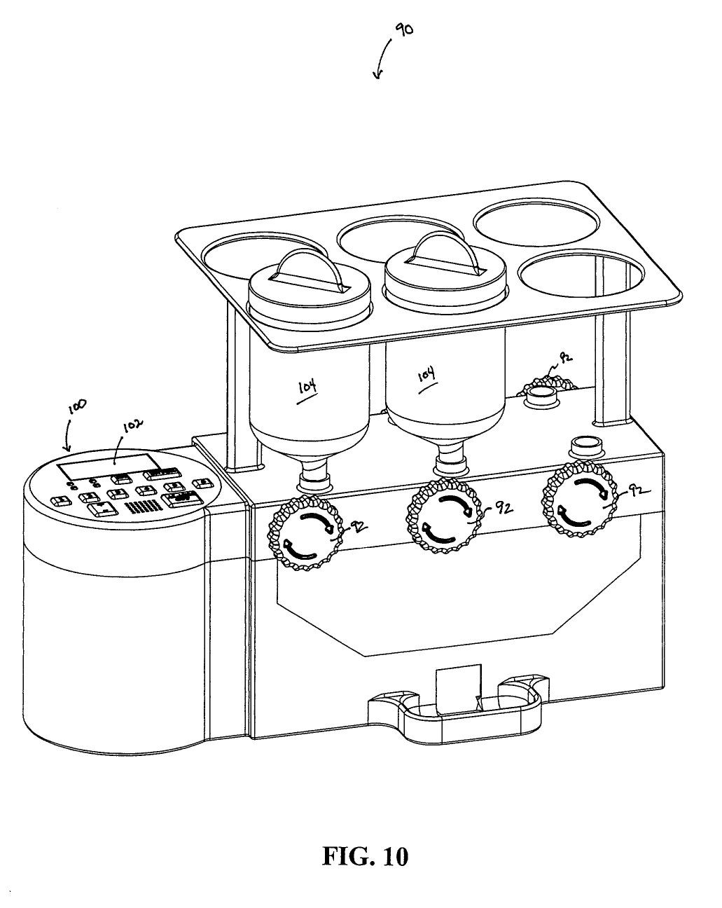

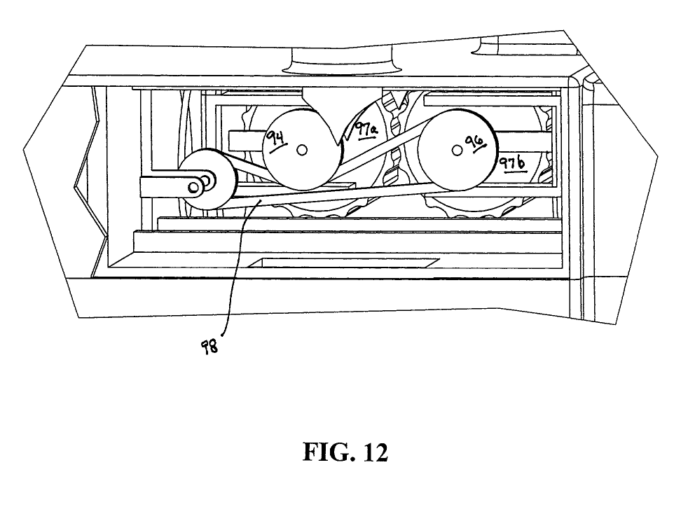

A pill dispensing apparatus 90 according to another embodiment of the present invention is shown in FIGS. 10-12 and includes a construction substantially similar to the construction of the apparatus 10 described above except as particularly noted below. In this embodiment, the dispensing assembly does not include motors and thus is not automatically energized by the control unit 100. Instead, each dispensing assembly includes a knob 92 coupled to one of the wheels, the wheels being connected together with a linkage. The linkage includes respective gears 94, 96 attached to respective wheels 97a, 97b and operated in opposing directions with a belt 98 (FIG. 12). Therefore, a rotation of a knob 92 causes the pair of wheels to rotate in opposing directions. The control unit 100 enables dosage information to be entered such that the alarms are activated at the predetermined times. The appropriate containers 104 from which pills need to be manually dispensed will be identified by number on the display 102. Then, the user may rotate the appropriate knobs 92 to dispense the indicated number of pills.

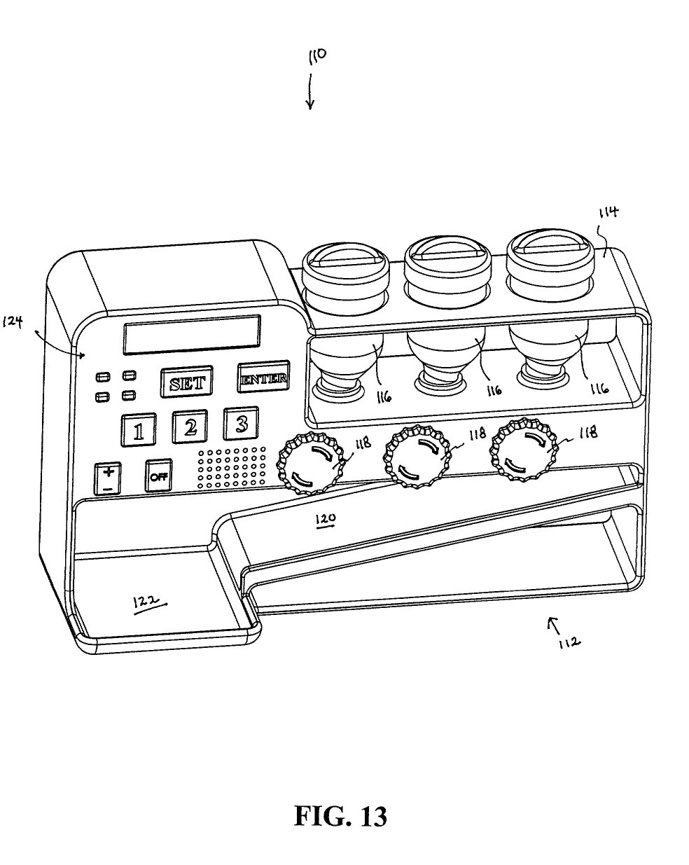

Another embodiment of the pill dispensing apparatus 110 is shown in FIG. 13 and includes a construction that is substantially similar to the embodiment shown in FIGS. 10-12 except as specifically noted below. The pill dispensing apparatus 110 according to the this embodiment includes a housing 112 having a rack 114 capable of holding fewer pill containers 116 than the previously described embodiments. This apparatus 110 includes manual dispensing assemblies with knobs 118 that operate in the same manner as described above. A ramp 120 is positioned within the housing 112 beneath the dispensing assemblies for directing dispensed pills to a collection tray 122 at the bottom of the housing 112. This apparatus 110 also includes a control unit 124 capable of receiving dosage data and notifying a user by alarm and display when pills need to be dispensed and taken. This embodiment of the pill dispensing apparatus 110 provides a simple and portable device for single-pill dispensing of medications.

Therefore, the pill dispensing apparatus according to the present invention allows quantities of individual prescription medications to be dispensed one pill at a time at predetermined times without any presorting or combining of different medications into dosage compartments.

It is understood that while certain forms of this invention have been illustrated and described, it is not limited thereto except insofar as such limitations are included in the following claims and allowable functional equivalents thereof.

Having thus described the invention, what is claimed as new and desired to be secured by Letters Patent is as follows:

1. A pill dispensing apparatus, comprising:
a container capable of holding a plurality of pills of the same medication and having a bottom wall defining an opening;
a housing having a bottom wall with upstanding front, rear, and side walls extending upwardly therefrom, said housing having a top wall spaced from said bottom wall and connected to said front, rear, and side walls such that said housing defines an interior space, said top wall defining an aperture having a configuration complementary to a configuration of said bottom wall opening in said container, said housing including an outlet;
means connected to said housing for holding said container such that said first open end of said container is aligned with said aperture of said top wall;
means for selectively dispensing a single pill from said container into said interior space of said housing and through said outlet.

2. The pill dispensing apparatus as in claim 1 further comprising a funnel connected to said container at said bottom wall opening, said funnel having an offset portion for directing said plurality of pills toward said dispensing means in single file alignment, whereby to inhibit blockage or jamming.

3. The pill dispensing apparatus as in claim 1 wherein said container defines an open top adapted to receive said plurality of pills into said container, said container including a cap for removably covering said open top.

4. The pill dispensing apparatus as in claim 1 wherein said dispensing means includes:
a framework positioned in said housing having a pair of frame elements biased toward one another with respective compression springs;
a pair of wheels rotatably mounted to respective frame elements of said framework such that edges of said pair of wheels are movable between a first configuration in which said edges bear substantially against one another and a second configuration in which said edges are spaced apart from one another, each edge of said pair of wheels having a grip surface;
a motor mounted to said framework and connected to said pair of wheels with a pair of shafts for rotating said pair of wheels in opposing directions when said motor is energized, a rotation of said pair of wheels conveying said single pill between said pair of wheels by said grip surfaces, said pair of wheels being moved between said first and second configurations as said single pill is conveyed therebetween so that said single pill is not damaged; and
a photoelectric sensor positioned beneath said pair of wheels and adapted to cause said motor to be de-energized upon sensing that said single pill has been conveyed completely between said pair of wheels and into said interior space.

5. The pill dispensing apparatus as in claim 4 further comprising a control unit, said control unit comprising:
a processor;
a keypad electrically connected to said processor for entering dosage data;
a memory for storing said dosage data;
a display connected to said processor for selectively displaying said dosage data or messages;
said processor being electrically connected to said motor for energizing said motor according to said dosage data.

6. The pill dispensing apparatus as in claim 5 further comprising an audible alarm and a visual alarm electrically connected to said processor, said processor adapted to energize said audible and visual alarms according to said dosage data.

7. The pill dispensing apparatus as in claim 1 wherein said dispensing means includes:
a framework positioned in said housing having a pair of frame elements biased toward one another with respective compression springs;
a pair of wheels rotatably mounted to respective frame elements of said framework such that edges of said pair of wheels are movable between a first configuration in which said wheels bear substantially against one another and a second configuration in which said wheels are spaced apart from one another, each edge of said pair of wheels having a grip surface;
a knob rotatably mounted to said front wall, said knob being coupled to said pair of wheels such that a rotation of said knob causes said pair of wheels to rotate in opposing directions, a rotation of said pair of wheels conveying said single pill between said pair of wheels by said grip surfaces, said pair of wheels being moved between said first and second configurations as said single pill is conveyed therebetween so that said single pill is not damaged.

8. The pill dispensing apparatus as in claim 8 wherein said knob is coupled to one of said pair of wheels, said pair of wheels being coupled together by a gear train such that a rotation of said knob causes said pair of wheels to rotate in opposing directions.

9. The pill dispensing apparatus as in claim 1 wherein said container is constructed of a transparent material.

10. A pill dispensing apparatus for dispensing medication, comprising:
a plurality of containers, each container being capable of holding a plurality of pills and having a bottom wall defining an opening;
a housing having a bottom wall with upstanding front, rear, and side walls extending upwardly therefrom, said housing having a top wall spaced from said bottom wall and connected to said front, rear, and side walls such that said housing defines an interior space, said top wall defining a plurality of apertures each having a configuration complementary to a configuration of a respective bottom wall opening of a respective container, said housing including an outlet;
a rack connected to said housing and adapted to hold said plurality of containers such that each bottom wall opening is aligned with a corresponding aperture in said top wall;
a funnel connected to each container at a respective bottom wall opening, each funnel having an offset portion for directing a respective plurality of pills therethrough in a single file alignment so as to inhibit blockage or jamming;
a control unit having means for inputting dosage data, a memory for storing said dosage data, and a processor;
an alarm electrically connected to said processor, said processor adapted to energize said alarm according to said dosage data;
a framework positioned in said interior space of said housing having a plurality of pairs of frame elements biased toward one another in slidable relation with respective compression springs;
a plurality of pairs of wheels rotatably mounted to respective frame elements of said framework such that each pair of wheels are movable between a first configuration in which edges of said pair of wheels bear substantially against one another and a second configuration in which said edges are spaced apart from one another, each edge of each wheel having a grip surface; and
means for actuating a respective pair of wheels to rotate in opposing directions, whereby to convey a single pill from a respective container between said respective pair of wheels and into said interior space of said housing.

11. The pill dispensing apparatus as in claim 10 wherein said actuating means comprises:
a plurality of motors electrically connected to said processor, each motor being mounted to said framework and connected to a respective pair of wheels for rotating said respective pair of wheels in opposing directions when energized, said processor being adapted to energize a respective motor according to said dosage data, a rotation of said pair of wheels conveying said single pill between said pair of wheels by said grip surfaces, said pair of wheels being moved between said first and second configurations as said single pill is conveyed therebetween so that said single pill is not damaged.

12. The pill dispenser apparatus as in claim 11 further comprising a plurality of photoelectric sensors, each photoelectric sensor being positioned beneath a respective pair of wheels and electrically connected to said processor, each photoelectric sensor adapted to deliver an electrical signal to said processor upon sensing that said single pill has been conveyed completely between said respective pair of wheels and into said interior space.

13. The pill dispenser apparatus as in claim 10 wherein said actuating means comprises:
a plurality of knobs rotatably mounted to said front and rear walls adjacent respective pairs of wheels; and
each knob being coupled to a corresponding pair of wheels such that a rotation of said knob causes said corresponding pair of wheels to rotate in opposing directions, whereby to convey said single pill from said respective container into a space between said respective pair of wheels, said respective pair of wheels moving between said first and second configurations such that said single pill is not damaged as said single pill is conveyed between said respective pair of wheels and into said interior space.

14. The pill dispensing apparatus as in claim 13 wherein a respective knob is coupled to one of said respective pair of wheels, said respective pair of wheels being coupled together by a gear train such that a rotation of said respective knob causes said respective pair of wheels to rotate in opposing directions.

15. The pill dispensing apparatus as in claim 10 wherein each container is constructed of a transparent material and includes a color indicium different from a color indicium of any other of said plurality of containers.

16. The pill dispensing apparatus as in claim 10 wherein each container defines an open top and includes a cap adapted to removably cover said open top.

17. The pill dispensing apparatus as in claim 10 wherein said control unit includes a display connected to said processor for displaying said dosage data and messages.
